(19) United States
(12) Patent Application Publication
(10) Pub. No.: US 2024/0314393 A1
(43) Pub. Date: Sep. 19, 2024

(54) INTEGRATING TUNER-BASED MEDIA CONTENT WITH SERVER-BASED MEDIA CONTENT IN A TELEVISION PLATFORM

(71) Applicant: GOOGLE LLC, Mountain View, CA (US)

(72) Inventors: Nicholas Staubach, Menlo Park, CA (US); Sergey Smirnov, Campbell, CA (US); David Wang, San Carlos, CA (US); Saurabh Palan, Mountain View, CA (US); Yuan Jing, San Jose, CA (US); Benjamin Baxter, Cincinnati, OH (US); Senhua Huang, Palo Alto, CA (US); Weijie Lin, San Jose, CA (US)

(21) Appl. No.: 18/183,700

(22) Filed: Mar. 14, 2023

(51) Int. Cl. H04N 21/462; H04N 21/438; H04N 21/482

(52) U.S. Cl. CPC H04N 21/4622; H04N 21/4383; H04N 21/4821

(57) ABSTRACT

According to some aspect, a method includes receiving tuner channel data identifying a tuner-based television channel scanned by a television tuner of a display device, retrieving, from a media provider database, a list of tuner-based television channels associated with a location of the display device, identifying the tuner-based television channel from the list using the tuner channel data, retrieving, from the media provider database, program data that identifies a program broadcasted by the tuner-based television channel, generating channel and program data for the tuner-based television channel based on the tuner channel data and the program data, and transmitting the channel and program data to the display device, where the channel and program data is configured to cause the display device to display at least a portion of the program data in a user interface of a media application executable by the display device.

### BACKGROUND

A display device (e.g., a television) may include a tuner configured to interpret digital signals to watch over-the-air television channels. Also, the display device may include one or more video streaming applications that provide television content from server-based television sources. In some examples, in order to switch between content provided by the video streaming application(s) and content provided by over-the-air television channels, a user may have to operate an input control on the display device to change video/audio inputs. In such cases, the user may have to view separate electronic programming guides to determine which programs to watch on which channels.

### SUMMARY

In some aspects, the techniques described herein relate to a method including: receiving, by a server computer, tuner channel data identifying a tuner-based television channel scanned by a television tuner of a display device; retrieving, from a media provider database, a list of tuner-based television channels associated with a location of the display device; identifying the tuner-based television channel from the list using the tuner channel data; retrieving, from the media provider database, program data that identifies a program broadcasted by the tuner-based television channel; generating channel and program data for the tuner-based television channel based on the tuner channel data and the program data; and transmitting, over a network, the channel and program data to the display device, the channel and program data configured to cause the display device to display at least a portion of the program data in a user interface of a media application executable by the display device.

In some aspects, the techniques described herein relate to a non-transitory computer-readable medium storing executable instructions that when executed by at least one processor cause the at least one processor to execute operations, the operations including: receiving, by a server computer, tuner channel data identifying a tuner-based television channel scanned by a television tuner of a display device; retrieving, from a media provider database, a list of tuner-based television channels associated with a location of the display device; identifying the tuner-based television channel from the list using the tuner channel data, including obtaining an identifier that identifies the tuner-based television channel in the media provider database; transmitting a program query to the media provider database, the program query including the identifier and information that identifies a time interval; receiving a program response from the media provider database, the program response including program data that identifies a program broadcasted by the tuner-based television channel during the time interval; and transmitting, over a network, the program data for display on a user interface of a media application executable by the display device, the program data, when displayed, configured to enable a user to select the tuner-based television channel from the user interface such that such that selection of the tuner-based television channel causes a display of media data from radio waves received via an antenna on the display device.

In some aspects, the techniques described herein relate to a display device including: an operating system; and a media application executable by the operating system, the media application configured to: transmit, to a media platform executable by a server computer, tuner channel data obtained from a television tuner of the display device, the tuner channel data identifying a tuner-based television channel; receive, from the media platform, channel and program data about the tuner-based television channel, the channel and program data identifying a first program broadcasted by the tuner-based television channel; and render information that identifies the first program and a second program broadcasted by a server-based television channel on a user interface of the media application.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a system for integrating tuner-based television channels with server-based television channels on a user interface of a display device according to an aspect.

FIG. 1B illustrates example communications between a display device and a media platform and example communications for retrieving information from a media provider database on the media platform according to an aspect.

FIG. 1C illustrates an example of the display device according to an aspect.

FIG. 1D illustrates an example of channel and program data associated with a tuner-based television channel according to an aspect.

FIG. 2 illustrates an example of an electronic program guide that includes tuner-based television channels and server-based television channels according to an aspect.

FIG. 3 illustrates an example of rendering a user interface (UI) object that displays multiple watch options including an option to watch a program from a tuner-based television channel.

FIG. 4 illustrates a flowchart depicting example operations of a media platform according to an aspect.

FIG. 5 illustrates a flowchart depicting example operations of a display device according to an aspect.

### DETAILED DESCRIPTION

This disclosure relates to a system configured to integrate tuner-based media content with server-based media content in a user interface (e.g., a unified user interface) of a display device (e.g., a smart television). The user interface enables a user to select media content from both tuner-based television channels and server-based television channels. Tuner-based television channels include television channels broadcasted over the air using radio waves. For example, a tuner-based television channel may be a terrestrial frequency over which a television station broadcasts audio and video data via radio waves to television receivers (e.g., via antennas and/or tuners). Server-based television channels include television channels streamed over a network such as the Internet. A server-based television channel may be digital data from a content provider that is streamed using an internet protocol (IP) transmission mechanism. The system may enable a single user interface to display information (e.g., detailed information) about programs broadcasted by the server-based television channels and programs broadcasted by the tuner-based television channels. A user may select one of the server-based television channels and the tuner-based television channels to watch from the same user interface. Selection of a tuner-based television channel causes a program, currently broadcasted by the tuner-based television channel, to be displayed from the radio waves received by an antenna and a tuner of the display device. Selection of a server-based television channel causes a program, currently broadcasted by the server-based television channel, to be displayed from a media stream received over a network such as the Internet.

The display device includes an operating system configured to execute one or more native applications, including a media application that provides television content (e.g., live television content). In some examples, the native applications include one or more streaming applications that enable media content items (e.g., programs) to be streamed to the display device. The media application may be associated with a number of server-based television channels, and the user interface of the media application may enable the user to select a particular program being broadcasted by a server-based television channel to watch on the display device. The media application may identify server-based television channels and programs broadcasted by the server-based television channels in a variety of different ways, including the displaying of an electronic guide program that identifies server-based television channels and the programs being broadcasted by the server-based television channels over a period of time. The media application may be associated with an account identifier or a device identifier, and, in some examples, the user may have signed-up for a subscription to obtain access to television content, e.g., the server-based television channels. In some examples, the server-based television channels are associated with one or streaming applications executable on the display device.

However, as discussed herein, the display device may integrate tuner-based television channels into the user interface of the media application that also provides the server-based television channels. In this manner, the user may view, navigate, and search through programs broadcasted by both server-based television channels and tuner-based television channels via a single user interface, which may avoid switching television inputs and/or user interfaces associated with different applications or devices. Integrating tuner-based television channels into a server-based television platform (e.g., including providing a user interface that enables the user to search, view, and select television content in a consistent, uniform manner from both sources) may be technically challenging because the amount of information received via a tuner on the display device may be limited and display devices (located in different locations) may detect different tuner-based television channels.

However, the system discussed herein may provide a technical solution that overcomes these technical problems by enabling a media platform, executable by one or more server computers, to receive tuner channel data about tuner-based television channels detected by the tuner on the display device. The media platform may use the tuner channel data to reconcile the detected tuner-based television channels with information stored in a media provider database. For reconciled tuner-based television channels, the media platform may enrich (e.g., supplement, add to, etc.) the tuner channel data with detailed information about the tuner-based television channels and programs broadcasted by the tuner-based television channels so that information across both television sources can be presented to the user in a consistent, uniform manner.

In further detail, the tuner is configured to operate with an antenna to execute a channel scan, which scans and detects tuner-based television channels across frequencies. The display device's operating system may obtain tuner channel data from the tuner. The tuner channel data may identify which tuner-based television channels are detected and available to be displayed on the display device. The tuner channel data may include the channel name and the channel number of a respective tuner-based television channel. In some examples, the tuner channel data includes one or more identifiers that identifies the type of tuner and/or the display device. In some examples, the tuner channel data obtained from the tuner may not include other types of metadata associated with the tuner-based television channel such as an image or logo, type(s) of the channel entity, etc. In some examples, the tuner channel data obtained from the tuner may not include information that identifies current programs and/or future programs broadcasted by the tuner-based television channel(s).

The media platform may receive, over the network, the tuner channel data from the display device. The media platform may include a live television engine configured to manage and provide television content to display devices having user accounts associated with the media platform. The live television engine includes a reconciliation engine configured to reconcile and enhance the limited tuner channel data with channel data and program data stored in a media provider database to generate enriched data (e.g., channel and program data) for the tuner-based television channel(s) detected by the tuner.

In further detail, the reconciliation engine may obtain a location of the display device, and retrieve, from the media provider database, a list of tuner-based television channels associated with the location of the display. For example, the reconciliation engine may receive a list of the tuner-based television channels within a geographical location (e.g., zip code, city, region, etc.) of the display device. Then, the reconciliation engine may identify a tuner-based television channel from the list of tuner-based television channels that corresponds to a tuner-based television channel identified in the tuner channel data. In some examples, the reconciliation engine may determine whether the channel name and/or the channel number identified in the tuner channel data corresponds to (e.g., matches) a name and/or a channel number identified in the list of tuner-based television channels retrieved from the media provider database. In response to a match, the reconciliation engine may retrieve other channel data associated with the tuner-based television channel such as the image or logo of the tuner-based television channel, an identifier that identifies the tuner-based television channel in the media provider database, and/or other information about the tuner-based television channel.

The reconciliation engine may retrieve, from the media provider database, program data that includes program(s) broadcasted by the tuner-based television channel during a time interval. In some examples, the reconciliation engine may transmit a program query to the media provider database to retrieve the program(s) broadcasted by the tuner-based television channel during the time interval. The program data may include information identifying a current program and one or more future programs. For each program, the program data may include a name (e.g., a display name), a description, an air date/time, duration, a maturity rating, and/or a program image. The reconciliation engine may generate channel and program data for each tuner-based television channel reconciled by the reconciliation engine. The channel and program data may include enriched data about the tuner-based television channel and the programs broadcasted by the tuner-based television channel. The channel and program data may include a combination of the tuner channel data, the channel data, and/or the program data.

The media platform may transmit media content to the display device to be displayed in the user interface, where the media content includes the channel and program data associated with the tuner-based television channels. In some examples, the list of reconciled tuner-based television channels are stored in a memory device at the operating system of the display device. In some examples, the program data for the tuner-based television channels are stored in the memory device of the operating system of the display device. In some examples, the media content also includes channel and program data associated with server-based television channels. In some examples, the media content, when executed by the display device, is configured to cause the display device to integrate the channel and program data of the tuner-based television channels with the channel and program data of the server-based television channels in a unified user interface of the media application.

The media application may render an electronic media guide in the user interface. The electronic programming guide may display a programming schedule of media content, e.g., programs from the tuner-based television channels and the server-based television channels. From the electronic programming guide, a user may view the programs from the tuner-based television channels and the server-based television channels across multiple time slots. In response to a selection to watch a tuner-based television channel, the media application may cause a media player to be launched to receive and display data received from the tuner of the display device. In response to a selection to watch a server-based television channel, the media application may receive content over the network (e.g., internet) from a streaming platform (e.g., which may be the media platform or another streaming platform).

The media application may provide recommendations (e.g., personalized to the user account) in the user interface for selection by the user. The recommendations may include programs from the server-based television channels and programs from the tuner-based television channels. In some examples, the media application may identify un-finished items (e.g., started but un-finished programs) associated with the tuner-based television channels in the user interface for selection by the user. In some examples, the media application may identify a program from the tuner-based television channel in a cluster of media content items. The cluster of media content items may be based on one or more categories, such as content type (e.g., “Action Movies”), viewing history (e.g., “Because You watched Movie ABC”), release time (e.g., “Trending”), and the like. In some examples, a program from the tuner-based television channel is included in one or more of the clusters. In some examples, a user may search for media content on the media platform. For example, the media platform may receive a search query, and, in response to the query, may provide search results for media content items (e.g., programs) available for viewing from the media platform. The search results may include programs from the tuner-based television channel(s) (e.g., previously reconciled and recorded as an entitlement) along with other types of media content items from streaming platforms.

The display device may receive a voice command to play a tuner-based television channel or a program on a tuner-based television channel. In some examples, the voice command is a command to display a particular television channel on the display device. In some examples, the voice command is a command to display a particular program broadcasted by a television channel on the display device. In response to the voice command, the operating system may cause a media player to launch to play the tuner-based television channel. In some examples, the display device may include a microphone, which, when activated, is configured to receive a voice command (e.g., “play channel six”). In some examples, the display device may receive the voice command from another device such as a smart speaker, smartphone, wearable device, etc. (e.g., “play channel six on home TV”).

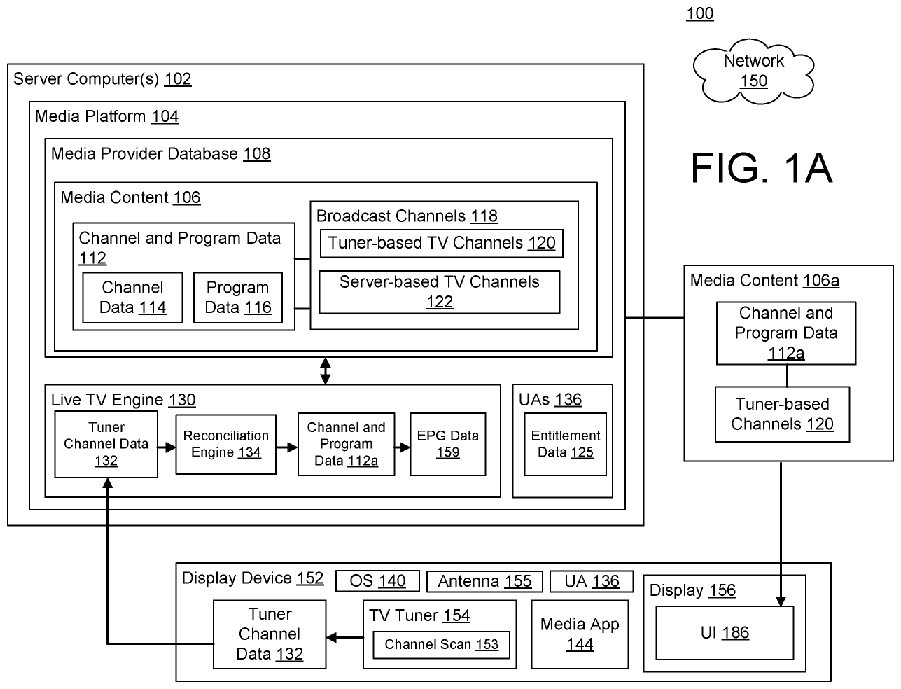

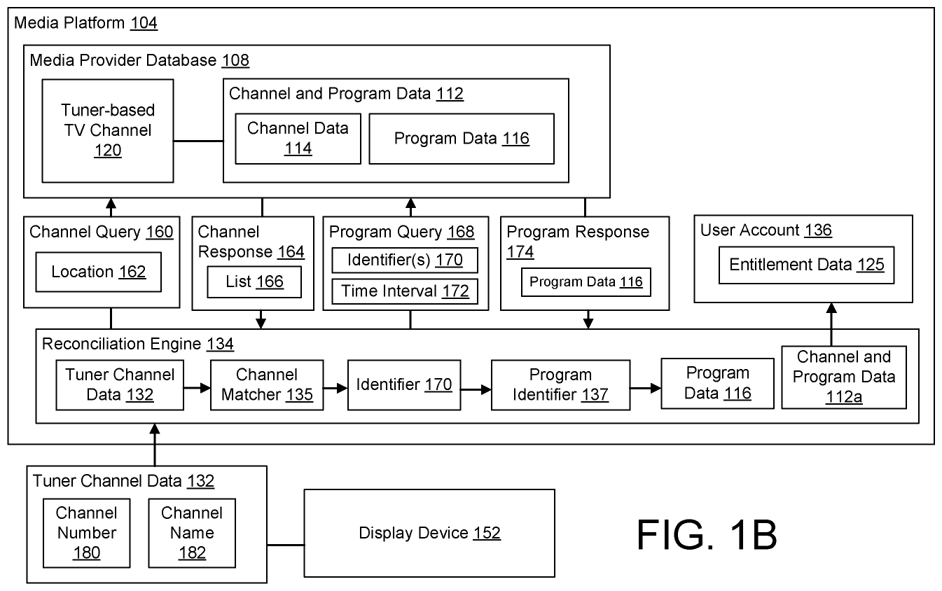

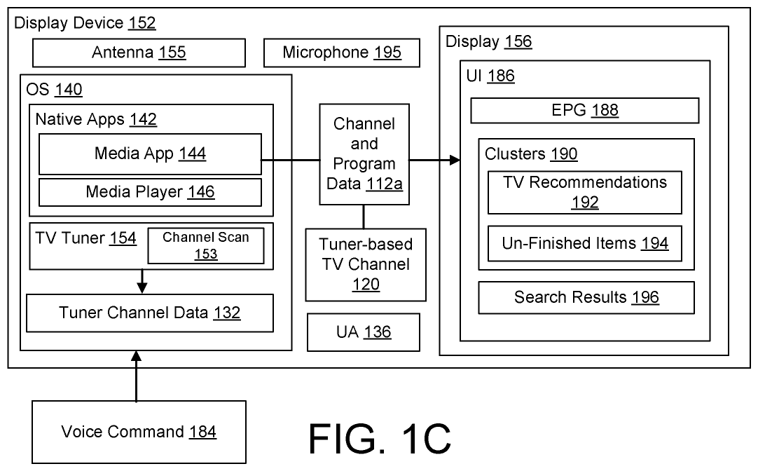

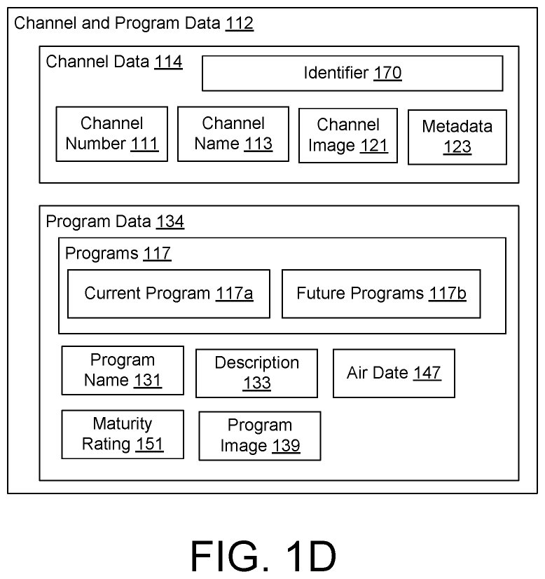

FIGS. 1A through 1D illustrate a system 100 configured to integrate tuner-based television content with server-based media content in a user interface 186 on a display device 152 (e.g., a smart television). The user interface 186 may display channel and program data 112a associated with one or more tuner-based television channels 120, and, in some examples, may display the channel and program data 112a with channel and program data 112 associated with one or more server-based television channels 122.

Displaying media content 106a associated with the tuner-based television channel 120 in the user interface 186 may include displaying UI element(s) in the user interface 186 that identifies a tuner-based television channel (e.g., channel name 113, channel number 111, channel image 121 (e.g., logo), etc.) and/or information about one or more programs 117 broadcasted by the tuner-based television channel 120 (e.g., program name 131, description 133, air date 147, maturity rating 137, and/or program image 139). The user interface 186 may enable a user to select a tuner-based television channel 120 or a server-based television channel 122, where selection of the tuner-based television channel 120 displays the current content of the tuner-based television channel 120 on the display device 152 from radio waves received by an antenna 155 of the display device 152 and selection of the server-based television channel 122 displays the current content of the server-based television channel 122 from digital data received over a network 150.

The system 100 of FIG. 1A includes a display device 152 configured to execute a media application 144, and one or more server computers 102 configured to execute a media platform 104 to identify and provide media content 106a for display and selection in the user interface 186 of the media application 144. The media platform 104 may be a server-based television platform. It is noted that the media content 106a is a subset of the media content 106 stored in a media provider database 108 that has been selected for a user account 136 associated with the display device 152. The media content 106a may include channel and program data 112a associated with one or more tuner-based television channels 120. Also, the media content 106a may include channel and program data 112 associated with one or more server-based television channels 122. Further, the media content 106a may include other media content items available for playback that are offered by the media platform 104 or other streaming platforms. FIG. 1B illustrates a more detailed diagram of the media platform 104. FIG. 1C illustrates an example of the display device 152. FIG. 1D illustrates an example of the channel and program data 112a generated by the media platform 104.

The media application 144 (e.g., in conjunction with the media platform 104) may aggregate (e.g., combine, assemble, collect, etc.) information about media content 106 available for viewing (e.g., streaming) from multiple streaming platforms and present the information in the user interface 186 (e.g., a single, unified user interface) so that a user can identify and/or search media content 106 across different streaming platforms (e.g., without having to search within each native application 142). In some examples, the media content 106 is referred to as media content items (e.g., individual programs broadcasted or offered by broadcast channels or streaming platforms). For example, each media content item may be a program 117 (e.g., a television show, a movie, a live broadcast, etc.) from a tuner-based television channel 120, a server-based television channel 122, the media platform 104, or another streaming platform. Instead of searching for media content items on a first native application and media content items on a second native application, the media application 144 may combine the media content items together in one interface (e.g., user interface 186) so that a user can search across multiple streaming platforms at once.

The media platform 104 may communicate, over a network 150, with the streaming platforms to identify which media content 106 is available to be streamed by display devices 152 and user devices. The media platform 104 may identify a set or multiple sets of media content items (e.g., across the various streaming platforms) as recommendations to a user of the media application 144. In some examples, the media platform 104 may determine whether the user of the media application 144 has rights (e.g., stored as entitlement data 125) to stream media content 106 from one or more of the streaming platforms (e.g., whether the user has subscribed to access media content 106 from the streaming platform(s)), and, if so, may include those media content items as candidates in a selection (e.g., ranking) mechanism to potentially be displayed in the user interface 186 of the media application 144.

In some examples, the user interface 186 may display media content 106a (e.g., a plurality of media content items), which may be selected by the media platform 104 based at least in part on information representing the user's interests and activities (e.g., the user's search queries, search results, previous watch history, purchase history, application usage history, application installation history, user actions on the network-connected television device, physical activities of the user, etc.). In some examples, the media application 144 may be associated with a user account 136, and the user account 136 may store the information representing the user's interests and activities, and the media platform 104 may use this information to select and present the media content items in the user interface 186. In some examples, the media content items may be organized as a plurality of clusters 190 based on one or more categories, such as content type (e.g., “Action Movies”), viewing history (e.g., “Because You watched Movie ABC”), release time (e.g., “Trending”), and the like. In some examples, the media content items provided by different streaming platforms (e.g., action movies from two different streaming services and a broadcast television channel) can be recommended in the same cluster 190. In some examples, the user interface 186 may include tabbed interfaces, where one of the tabbed interfaces includes personalized media content that is organized as a plurality of clusters 190 based on one or more categories, such as release time (e.g., “This Week,” “Next week,” “Next Month,” etc.), user action and user application interaction, native app usage (e.g., items that are “From App ABC”), etc.

It is noted that a user of the media application 144 may be provided with controls allowing the user to make an election as to both if and when the system 100 may enable the collection of information representing the user's interests and activities. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user of the media application 144 may have control over what information is collected about the user, how that information is used, and what information is provided to the user and/or to the server computer 102.

The media platform 104 may include a live television engine 130 configured to provide broadcast channels 118 for selection and playback in the user interface 186. The broadcast channels 118 may include server-based television channels 122, e.g., channels delivered over the network 150. The server-based television channels 122 may include channels offered by the media platform 104 (e.g., a user may subscribe to a live television package associated with the media platform 104). In some examples, the server-based television channels 122 include channels offered by one or more streaming platforms in which the user account 136 (or a device) has entitlements (e.g., stored as entitlement data 125) to access. For example, a native application 142 associated with a first streaming platform may be installed on the operating system 140, and the first streaming platform may include a live television package having a set of server-based television channels 122. As discussed herein, the live television engine 130 may incorporate tuner-based television channels 120 into the user interface 186 that also identifies server-based television channels 122 and/or other server-based content.

The tuner-based television channels 120 include television channels broadcasted over the air using radio waves. A tuner-based television channel 120 may be a terrestrial frequency over which a television station broadcasts audio and video data via radio waves to television receivers. A tuner-based television channel 120 may represent a broadcasting order of programs 117 (e.g., live or pre programmed) by a content provider in which the programs 117 are broadcasted via radio waves according to the broadcasting order. Selecting or joining a tuner-based television channel 120 from the user interface 186 may initiate the display of a current program at a current time in the broadcasting order.

The server-based television channels 122 include television channels streamed over a network 150 such as the Internet. A server-based television channel 122 may be digital data from a content provider that is streamed using an internet protocol (IP) transmission mechanism. A server-based television channel 122 may represent a broadcasting order of programs (e.g., live or preprogrammed) by a content provider in which the programs are streamed over the network 150 according to the broadcasting order via the network 150. In some examples, the programs of a server-based television channel 122 are not video-on-demand programs. Selecting or joining a server-based television channel 122 from the user interface 186 may initiate the display of a current program at a current time in the broadcasting order. In some examples, a user may rewind a program of the server-based television channel 122 (or rewind to a previous program) or cause a program of the server-based television channel 122 to be recorded and later replayed as a video-on-demand program.

The system 100 may enable the user interface 186 to display information (e.g., detailed information) about programs 117 broadcasted by the server-based television channels 122 and programs 117 broadcasted by the tuner-based television channels 120 and a user may select content to watch from the server-based television channels 122 and the tuner-based television channels 120 on the same user interface 186. Selection of a tuner-based television channel 120 causes content, currently broadcasted by the tuner-based television channel 120, to be displayed on a display 156 of the display device 152. The content of the tuner-based television channel 120 may be received in the form of a radio signal at an antenna 155 of the display device 152. Selection of a server-based television channel 122 causes content, currently broadcasted by the server-based television channel 122, to be displayed on the display 156 of the display device 152. The content of the server-based television channel 122 may be received over the network 150 in the form of digital data according to an IP transmission mechanism.

The display device 152 may be a network-enabled display device configured to connect to the network 150. In some examples, the display device 152 includes a television (e.g., a smart television). The display device 152 includes a tuner 154 and an antenna 155. In some examples, the tuner 154 includes the antenna 155 (e.g., the antenna 155 is integrated into the tuner 154). The antenna 155 may receive radio waves from a broadcasting station. The tuner 154 may process (e.g., interpret) the radio waves received by the antenna 155 to generate a digital signal capable of being displayed on the display device 152.

The display device 152 includes one or more processors, one or more memory devices, and an operating system 140 configured to execute (or assist with executing) one or more native applications 142. The native applications 142 may include a media application 144 configured to communicate, over the network, 150, with a media platform 104 executable by one or more server computers 102. In some examples, the media application 144 is a program that is part of the operating system 140. In some examples, the media application 144 is a separate standalone application that is downloaded and installed on the operating system 140. In some examples, the native applications 142 includes a media player 146, which, when launched, is configured to display content received via the tuner 154. In some examples, the media application 144 may execute operation(s) discussed with reference to the operating system 140 (and/or vice versa). In some examples, the display device 152 is not a smart television, but is converted to a smart television when connected to a casting device, where the casting device is configured to connect to the network 150 and execute an operating system 140 configured to execute native applications 142, including the media application 144.

In some examples, the operating system 140 is a browser application. A browser application is a web browser configured to access information on the Internet and may launch one or more browser tabs in the context of one or more browser windows. In some examples, the operating system 140 is a Linux-based operating system. In some examples, the operating system 140 is a mobile operating system that is also configured to execute on smaller devices (e.g., smartphones, tablets, wearables, etc.).

The tuner 154 is configured to operate with the antenna 155 to execute a channel scan 153, which scans and detects tuner-based television channels 120 across frequencies. In response to a channel scan 153, the operating system 140 of the display device 152 may obtain tuner channel data 132 from the tuner 154 and store the tuner channel data 132 in a memory device of the display device 152. In some examples, the tuner 154 executes the channel scan 153 in a background process of the display device 152. In some examples, the tuner 154 is configured to automatically execute the channel scan 153 when the display device 152 is powered-on.

The tuner channel data 132 may identify which tuner-based television channels 120 are detected by the tuner 154 on the display device 152. For each tuner-based television channel 120 detected by the tuner 154, the tuner channel data 132 may include a channel number 180 and a channel name 182. The channel number 180 may be a numerical identifier (e.g., 11, 11.2, 12, 25.2, etc.) associated with a particular tuner-based television channel 120. The channel name 182 may be the title/name associated with a particular tuner-based television channel 120. In some examples, the tuner channel data 132 includes one or more identifiers that identifies the type of tuner 154 and/or the display device 152. In some examples, the tuner channel data 132 may not include other types of metadata associated with the tuner-based television channel 120 such as an image or logo, type(s) of the channel entity, etc. In some examples, the tuner channel data 132 may not include programming data, e.g., information that identifies current programs 117a and/or future programs 117b to be broadcasted by a tuner-based television channel 120. In some examples, the tuner channel data 132 includes information that identifies a current program 117a broadcasted by a respective tuner-based television channel 120 but not future programs 117b to be broadcasted by a respective tuner-based television channel 120.

The media platform 104 may receive, over the network 150, the tuner channel data 132 from the display device 152. The media platform 104 may include a media provider database 108 that stores information about media content 106 that can be presented and selected from the user interface 186. The media content 106 may include channel and program data 112 for a plurality of broadcast channels 118, including the tuner-based television channels 120 and the Server-based television channels 122. The channel and program data 112 may represent a relatively large set of data that provides information for many broadcast channels 118 that can be viewed by a user (e.g., across one or multiple countries). The channel and program data 112 may include channel data 114 that includes information about the broadcast channels 118 and program data 116 that includes information about programs that are broadcasted by the broadcast channels 118. In some examples, the media platform 104 may receive (e.g., periodically receive) the channel and program data 112 from an external source and store (e.g., update) the channel and program data 112 in the media provider database 108. In some examples, the media content 106 may include other media content such as media content offered by one or more multiple video streaming platforms.

As shown in FIG. 1D, the media provider database 108 may store enriched data relating to the broadcast channels 118 (e.g., both the server-based television channels 122 and the tuner-based television channels 120). For example, for each broadcast channel 118, the channel data 114 may include an identifier 170 that identifies a respective broadcast channel 118 in the media provider database 108, a channel number 111, a channel name 113, a channel image 121 (e.g., a logo or image associated with the channel), and/or other metadata 123 about the broadcast channel 118 such as whether the broadcast channel 118 is a server-based television channel 122 or a tuner-based television channel 120. Also, for each broadcast channel 118, the media provider database 108 may include program data 116. The program data 116 may include information that identifies a current program 117a and one or more future programs 117b. For each program 117, the program data 116 may include a program name 131, a description 133, an air date 147, a maturity rating 137, and/or a program image 139.

Referring back to FIG. 1A, the live television engine 130 includes a reconciliation engine 134 configured to receive the tuner channel data 132 and generate channel and program data 112a for one or more of the tuner-based television channel(s) 120 detected by the tuner 154. The channel and program data 112a may represent enriched information about a tuner-based television channel 120 and about programs 117 broadcasted by a tuner-based television channel 120.

In other words, the reconciliation engine 134 may reconcile and enhance the tuner channel data 132 with channel and program data 112 stored in the media provider database 108 to generate enriched data (e.g., channel and program data 112a) for the tuner-based television channel(s) 120 detected by the tuner 154. For example, the information obtained by the tuner 154 (e.g., the tuner channel data 132) may be insufficient to enable the tuner-based television channels 120 to be presented in a user interface 186 that also identifies and displays information from server-based television channels 122 or other server-side media content. However, the reconciliation engine 134 may reconcile the tuner-based television channels 120 detected by the tuner 154 with known information stored in the media provider database 108 and enrich the limited tuner channel data 132 with additional information stored in the media provider database 108.

In some examples, the reconciliation engine 134 obtains a location 162 of the display device 152. The location 162 may represent a geographic area of the location in which the display device 152 is located. In some examples, the reconciliation engine 134 obtains the location 162 from a user account 136 stored on the media platform 104. In some examples, the location 162 is included in the tuner channel data 132. The user account 136 may include information that identifies one or more display devices 152 associated with the user account 136. In some examples, the location 162 includes a zip code of the area in which the display device 152 is located. In some examples, the location 162 includes a geolocation location or geolocation coordinates of the display device 152.

As shown in FIG. 1B, in response to receiving the tuner channel data 132, the reconciliation engine 134 may generate and transmit a channel query 160 to the media provider database 108. In some examples, the channel query 160 includes the location 162 of the display device 152. The channel query 160 may be a request to retrieve a list 166 of tuner-based television channels 120 that are available in the location 162. In response to the channel query 160, the media platform 104 may retrieve a list 166 of tuner-based television channels 120 that are broadcasted in the location 162 of the display device 152. If the location 162 is a zip code, the list 166 includes information that identifies the tuner-based television channels 120 that are broadcasted in the zip code specified by the channel query 160. The reconciliation engine 134 may receive a channel response 164 that includes the list 166. In some examples, for each channel-based television channel 120 that is broadcasted in the location 162, the list 166 may include an identifier 170 that identifies a respective tuner-based television channel 120 on the media platform 104, a channel number 111, and a channel name 113.

The reconciliation engine 134 may include a channel matcher 135 configured to reconcile the tuner-based television channels 120 identified by the tuner channel data 132 with the tuner-based television channels 120 identified in the list 166. For example, the channel matcher 135 may identify a tuner-based television channel 120 from the list 166 of tuner-based television channels 120 that corresponds to a tuner-based television channel 120 identified in the tuner channel data 132.

In some examples, the channel matcher 135 may determine whether the channel number 180 and/or the channel name 182 identified in the tuner channel data 132 corresponds to (e.g., matches) the channel number 111 and/or the channel name 113 from the list 166. In some examples, if the channel number 180 corresponds to the channel number 111, the channel matcher 135 may identify the corresponding tuner-based television channel 120 as eligible to be used in the system 100. In some examples, if the channel name 182 corresponds to the channel name 113, the channel matcher 135 may identify the corresponding tuner-based television channel 120 as eligible to be used in the system 100. In some examples, the channel matcher 135 uses both the channel number and the channel name, e.g., if the channel number 180 corresponds to the channel number 111 and the channel name 182 corresponds to the channel name 113, the channel matcher 135 identifies the corresponding tuner-based television channel 120 as eligible to be used in the system 100.

In some examples, if a tuner-based television channel 120 identified in the tuner channel data 132 is not identified (e.g., does not match) a tuner-based television channel 120 on the list 166, the tuner-based television channel 120 is not used in the system 100. In some examples, if a tuner-based television channel 120 identified in the tuner channel data 132 is not identified (e.g., does not match) a tuner-based television channel 120 on the list 166, the tuner-based television channel 120 is still used in the system 100 but may be presented in the user interface 186 with limited information.

In response to a match, the reconciliation engine 134 may retrieve channel data 114 associated with the tuner-based television channel 120 such as a channel image 121 (e.g., logo) and/or other metadata 123 associated with the tuner-based television channel 120 from the media provider database 108.

The reconciliation engine 134 may include a program identifier 137 configured to retrieve, from the media provider database 108, program data 116 that identifies program(s) 117 broadcasted by the tuner-based television channel(s) 120 during a time interval 172. For example, the program identifier 137 may generate and transmit a program query 168 to the media provider database 108. The program query 168 may be a request to retrieve program data 116 about the programs 117 broadcasted by tuner-based television channels 120 (e.g., that have been identified or reconciled, or, in other words, have an identifier 170). The program query 168 may include the identifier(s) 170 of the tuner-based television channel(s) 120, which have been previously reconciled. In some examples, the program query 168 may include information that identifies a time interval 172. The time interval 172 may define a duration such as one day, one week, one month, etc. In some examples, the time interval 172 is defined by a start time and an end time.

In response to the program query 168, the media platform 104 may query the media provider database 108 to retrieve program data 116 associated with each identifier 170 during the time interval 172. The program identifier 137 may receive a program response 174 that includes the program data 116 for each identifier 170 associated with the tuner-based television channels 120. The program data 116 may include information identifying a current program 117a and one or more future programs 117b during the time interval 172. For each program 117, the program data 116 may include a name 131, a description 133, an air date 147 (e.g., time/date of broadcast), a maturity rating 137, and/or a program image 139.

The reconciliation engine 134 may generate channel and program data 112a for the tuner-based television channels 120 that are reconciled by the channel matcher 135. The channel and program data 112a may include enriched data about the tuner-based television channel 120 and the programs 117 broadcasted by the tuner-based television channel 120. The channel and program data 112a may include a combination of the tuner channel data 132, the channel data 114, and/or the program data 116. In some examples, if the channel name 182 is different from the channel name 113, the channel and program data 112a may include the channel name 113 (e.g., from the media provider database 108) as the display name.

In some examples, the media platform 104 may store entitlement data 125 in a user account 136 of the media application 144. In some examples, the media platform 104 may store the entitlement data 125 in association with an account identifier of the user account 136 or a device identifier of the display device 152. If the entitlement data 125 is stored in association with the device identifier, multiple user accounts on the display device 152 may be provided access to the tuner-based content. The entitlement data 125 may identify which media providers the user account 136 (or the display device 152) has access to, which may include media providers associated with one or more native applications 142. Also, the entitlement data 125 may associate the user account 136 (and/or the display device 152) with the reconciled tuner-based television channels 120. For example, the entitlement data 125 may include a list of tuner-based television channels and the list is associated with a tuner 154 or display device 152 (e.g., the tuner 154 or the display device 152 is the media provider). When the media platform 104 determines which media content 106 to select or recommend for the user account 136, the media platform 104 may determine which media providers are associated with the user account 136 (or the display device 152) using the entitlement data 125.

In some examples, the media platform 104 may receive new tuner channel data 132 from the display device 152. In some examples, the media platform 104 may receive new tuner channel data 132 in response to a new channel scan 153 by the tuner 154. In some examples, the media platform 104 may receive new tuner channel data 132 if the new channel scan 153 results in a list of tuner-based broadcast channels 120 that are different from the list of tuner-based broadcast channels 120 from a previous channel scan 153. In response to the new tuner channel data 132, the media platform 104 may generate updated channel and program data 112a and may update the entitlement data 125 with the updated channel and program data 112a. For example, the live television engine 130 (e.g., the reconciliation engine 134) may perform the same operations discussed above to generate the updated channel and program data 112a.

The media platform 104 may transmit media content 106a to the display device 152, where the media content 106a includes the channel and program data 112a associated with the tuner-based television channels 120. The media content 106a may represent a portion of the media content 106 stored on the media platform 104, which is selected for the user account 136 associated with the display device 152. In some examples, a list of reconciled tuner-based television channels 120 are stored in a memory device of the display device 152. In some examples, the program data 116 for the reconciled tuner-based television channels 120 in the memory device of the display device 152. In some examples, the media content 106a also includes channel and program data 112 associated with server-based television channels 122 or other media content items associated with one or more streaming platforms. In some examples, the media content 106a, when executed by the display device 152, is configured to cause the display device 152 to integrate the channel and program data 112a of the tuner-based television channels 120 with the channel and program data 112 of the server-based television channels 122 in the user interface 186.

In some examples, the live television engine 130 (or the media application 144) may generate electronic programming guide data 159. The electronic programming guide data 159 may include the channel and program data 112a associated with the tuner-based television channel 120 and channel and program data 112 for a server-based television channel 122. In some examples, the live television engine 130 may transmit the electronic programming guide data 159 to the display device 152. The electronic programming guide data 159 is configured to be rendered in an electronic programming guide 188 in the user interface 186 of the media application 144. The electronic programming guide 188 identifies the tuner-based television channel 120 and the server-based television channel 122.

For example, the electronic media guide 188 may display a programming schedule of media content, e.g., programs 117 from the tuner-based television channels 120 and programs 117 from the server-based television channels 122. From the electronic media guide 188, a user may view the programs 117 in a current time slot (and a future time slot) available for viewing from the tuner-based television channels 120 and the server-based television channels 122. In response to a selection to watch a tuner-based television channel 120, the media application 144 may cause a media player 146 to be launched to receive and display the content received via the tuner 154 and antenna 155 on the display device 152. In response to a selection to watch a server-based television channel 122, the media application 144 may receive content over the network (e.g., internet) from a streaming platform.

In some examples, the media application 144 may provide television recommendations 192 (e.g., personalized to the user account 136) in the user interface 186 for selection by the user. The television recommendations 192 may include programs 117 from the server-based television channels 122 and programs 117 from the tuner-based television channels 120. In some examples, the media application 144 may identify un-finished items 194 (e.g., un-finished programs 117 or programs 117 that have been started but not finished) in the user interface 186 for selection by the user. In some examples, the un-finished items 194 may include programs 117 from the server-based television channels 122 and programs 117 from the tuner-based television channels 120.

In some examples, the media platform 104 may receive a search query from the display device 152. The search query may be a request to search media content 106 in the media provider database 108. The search query may include one or more terms submitted by a user of the display device 152. In response to the search query, the media platform 104 may transmit search results 196 for display on the user interface 186 associated with the display device 152. The search results 196 may identify the program 117 broadcasted by the tuner-based television channel 120, one or more programs 117 broadcasted by a server-based television channel 122, and/or one or more media content items associated with one or more streaming platforms. For example, the search results 196 may include one or more programs 117 broadcasted by one or more tuner-based television channels 120 that were previously reconciled and recorded as an entitlement (e.g., stored as entitlement data 125).

In some examples, the display device 152 may receive a voice command 184 to play a tuner-based television channel 120 or a program 117 on a tuner-based television channel 120. In some examples, the voice command 184 is a command to display a particular television channel on the display device 152. In some examples, the voice command 184 is a command to display a particular program 117 broadcasted by a television channel on the display device. In response to the voice command 184, the operating system 140 may cause a media player 146 to launch to play the tuner-based television channel 120. In some examples, the display device 152 may include a microphone 195, which, when activated, is configured to receive a voice command 184 (e.g., “play channel six”). In some examples, the display device 152 may receive the voice command 184 from another device such as a smart speaker, smartphone, wearable device, etc. (e.g., “play channel six on home TV”).

The user interface 186 may include an arrangement of media content 106 from various streaming platforms and the tuner-based television channels 120. For example, the user interface 186 may identify first media content items available for streaming from a first streaming platform and second media content items available from a second streaming platform. The first media content items may identify video-on-demand programs and programs 117 from the server-based television channels 122 and/or other platform channels associated with the first streaming platform. Similarly, the second media content items may identify video-on-demand programs and programs 117 from the server-based television channels and/or other platform channels associated with the second streaming platform. In some examples, the media content 106 may include third media content items corresponding to programs 117 from the tuner-based television channels 120.

In some examples, the user interface 186 may include a plurality of clusters 190 of media content items such as a personalized recommendation cluster (e.g., recommendations 192), a top media content item cluster, an un-finished items cluster (e.g., un-finished items 194), one or more topic clusters (e.g., documentaries, action, horror, sports, etc.). The clusters 190 may include video-on-demand programs, programs 117 from the tuner-based television channels 120, and/or programs 117 from the server-based television channels 122.

The server computer 102 may be computing devices that take the form of a number of different devices, for example a standard server, a group of such servers, or a rack server system. In some examples, the server computer 102 may be a single system sharing components such as processors and memories. The network 150 may include the Internet and/or other types of data networks. such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

The server computer 102 may include one or more processors formed in a substrate, an operating system (not shown) and one or more memory devices. The memory devices may represent any kind of (or multiple kinds of) memory (e.g., RAM, flash, cache, disk, tape, etc.). In some examples (not shown), the memory devices may include external storage, e.g., memory physically remote from but accessible by the server computer 102. The server computer 102 may include one or more modules or engines representing specially programmed software.

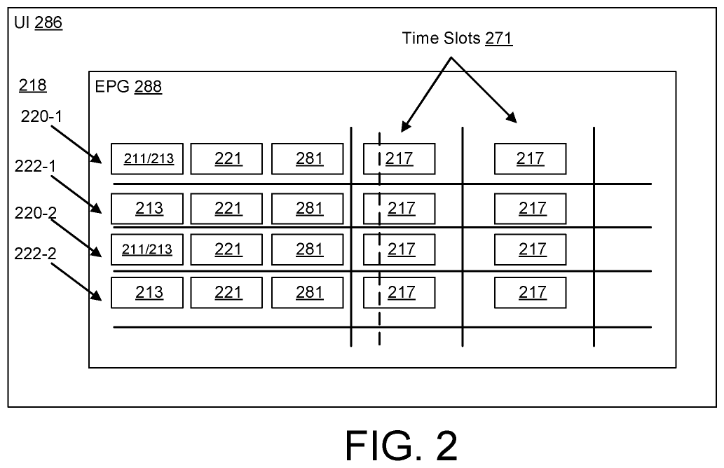

FIG. 2 illustrates an example of an electronic programming guide 288 rendered in a user interface 286 of a media application according to an aspect. The electronic programming guide 288 incorporates tuner-based television channels (e.g., 220-1, 220-2) with server-based television channels (222-1, 222-2). For example, the electronic programming guide 288 may identify programs 217 across time slots 271 and broadcast channels 218 (e.g., the server-based television channels and the tuner-based television channels). Each row may correspond to a different broadcast channel 218 and each row may include information about a respective broadcast channel 218 (e.g., channel number 211, channel name 213, and/or channel image 121) and indicate one or more programs 217 broadcasted by a respective broadcast channel 218.

The electronic programming guide 288 may include a first row relating to a tuner-based television channel 220-1 and may include the channel number 211, the channel name 213, and the channel image 221 associated with the tuner-based television channel 220-1. In some examples, the first row may include a preview video 281 that shows the content currently being broadcasted by the tuner-based television channel 220-1. Also, the first row includes information that identifies a program 217, broadcasted by the tuner-based television channel 220-1, in a time slot 271 (e.g., a current time slot), a program 217, also broadcasted by the tuner-based television channel 220-1, in a subsequent time slot 271 (e.g., a future time slot), and so forth.

The electronic programming guide 288 may include a second row relating to a server-based television channel 222-1 and may include the channel name 213, and the channel image 221 associated with the server-based television channel 222-1. In some examples, the second row may include a preview video 281 that shows the content currently being broadcasted by the server-based television channel 222-1. Also, the second row includes information that identifies a program 217, broadcasted by the server-based television channel 222-1, in a time slot 271 (e.g., a current time slot), a program 217, also broadcasted by the server-based television channel 222-1, in a subsequent time slot 271 (e.g., a future time slot), and so forth. In some examples, the electronic programming guide 288 includes a third row and a fourth row associated with a tuner-based television channel 220-2 and a server-based television channel 222-2, respectively.

The user may select one of the broadcast channels 218 to watch from the electronic programming guide 288. Selection of the tuner-based television channel 220-1 or the tuner-based television channel 220-2 causes content, currently broadcasted by the tuner-based television channel 220-1 or the tuner-based television channel 220-2, to be displayed on a display of the display device. The content of the tuner-based television channel 220-1 or the tuner-based television channel 220-2 may be received in the form of a radio signal at an antenna of the display device. Selection of the server-based television channel 222-1 or the server-based television channel 222-2 causes content, currently broadcasted by the server-based television channel 222-1 or the server-based television channel 222-2, to be displayed on a display of the display device. The content of the server-based television channel 222-1 or the server-based television channel 222-2 may be received over the network in the form of digital data according to an IP transmission mechanism.

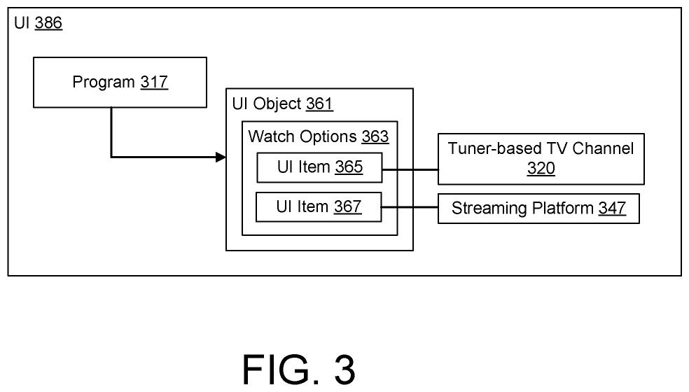

FIG. 3 illustrates an example of selecting a program 317 having multiple watch options 363 from a user interface 386 of a display device. The program 317 may be identified on the user interface 386 in one or more various locations in the user interface 386. The program 317 may be identified in an electronic programming guide or another section of the user interface 386 such as television recommendations (e.g., television recommendations 192 of FIGS. 1A through 1D), un-finished items (e.g., un-finished items 194 of FIGS. 1A through 1D), and/or search results (e.g., search results 196 of FIGS. 1A through 1D). In response to the program 317 being selected, the media application may render a UI object 361 that provides multiple watch options 363. The program 317 may be currently playing on a tuner-based television channel 320 or available to watch from a streaming provider 347. The UI object 361 may include a UI item 365, which, when selected, causes the program 317 to be displayed from media data received via the antenna and tuner. The UI object 361 may include a UI item 367, which, when selected, causes the program 317 to be displayed from media data received over the network from a streaming platform.

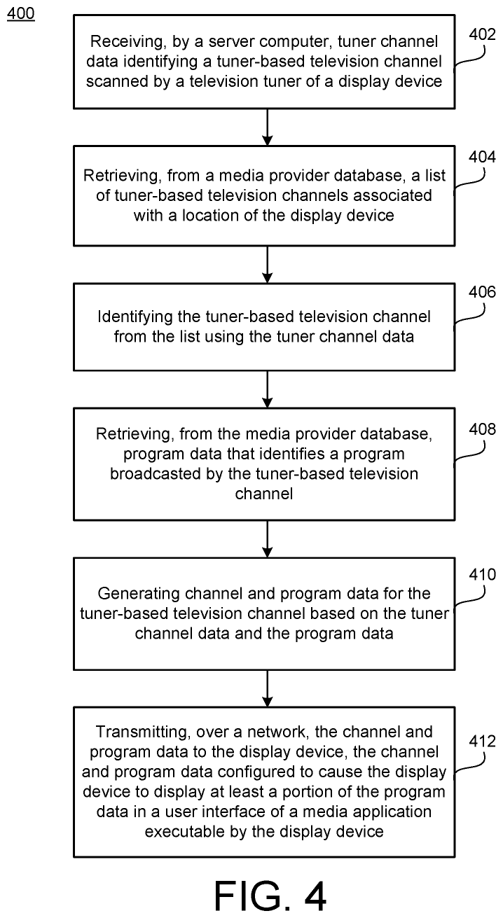

FIG. 4 illustrates a flowchart 400 depicting example operations of a media platform for integrating tuner-based content into a server-based television platform according to an aspect. Although the flowchart 400 of FIG. 4 illustrates the operations in sequential order, it will be appreciated that this is merely an example, and that additional or alternative operations may be included. Further, operations of FIG. 4 and related operations may be executed in a different order than that shown, or in a parallel or overlapping fashion. The operations may define a computer-implemented method. Although the flowchart 400 is described with reference to the system 100 of FIGS. 1A through 1D, the flowchart 400 may be executed according to any of the figures discussed herein. In some examples, the operations of the flowchart 400 are executed by a media platform 104 executable by one or more server computers 102.

Operation 402 includes receiving, by a server computer, tuner channel data identifying a tuner-based television channel scanned by a television tuner of a display device. Operation 404 includes retrieving, from a media provider database, a list of tuner-based television channels associated with a location of the display device. Operation 406 includes identifying the tuner-based television channel from the list using the tuner channel data. Operation 408 includes retrieving, from the media provider database, program data that identifies a program broadcasted by the tuner-based television channel. Operation 410 includes generating channel and program data for the tuner-based television channel based on the tuner channel data and the program data. Operation 412 includes transmitting, over a network, the channel and program data to the display device, the channel and program data configured to cause the display device to display at least a portion of the program data in a user interface of a media application executable by the display device.

In some examples, the operations include retrieving, from the media provider database, channel data for the tuner-based television channel, where the channel and program data for the tuner-based television channel includes the channel data. The channel data may include information that identifies an image associated with the tuner-based television channel. The tuner channel data may include at least one of a channel name or a channel number, where the identifying includes matching at least one of the channel name or the channel number with at least one of a channel name or a channel number from the list of tuner-based television channels. In some examples, the operations may include, in response to identifying the tuner-based television channel from the list, obtaining an identifier associated with the tuner-based television channel and transmitting a program query to the media provider database, where the program query includes the identifier and information that identifies a time interval. The operations may include receiving a program response from the media provider database, where the program response includes the program data that identifies the program broadcasted by the tuner-based television channel. In some examples, the program data includes at least of a program name, a description, an air date, a maturity rating, and a program image.

In some examples, the operations may include storing, at the server computer, entitlement data associated with an account identifier or a device identifier, where the entitlement data identifies a plurality of tuner-based television channels associated with the account identifier or the device identifier. The operations may include receiving, from the display device, new tuner channel data in response to a new channel scan by the television tuner. In some examples, in response to the new tuner channel data, the operations may include generating updated channel and program data and updating the entitlement data with the updated channel and program data. In some examples, the channel and program data is first channel and program data, and the operations may include generating electronic programming guide data, where the electronic programming guide data includes the first channel and program data associated with the tuner-based television channel, and second channel and program data for a server-based television channel.

The operations may include transmitting the electronic programming guide data to the display device, where the electronic programming guide data is configured to be rendered in an electronic programming guide in the user interface of the media application. The electronic programming guide may identify the tuner-based television channel and the server-based television channel. In some examples, the electronic programming guide data, when rendered in the electronic programming guide, is configured to enable a user to select the tuner-based television channel from the electronic programming guide such that selection of the tuner-based television channel causes a display of media data from radio waves received via an antenna on the display device, and the electronic programming guide data, when rendered in the electronic programming guide, is configured to enable the user to select the server-based television channel from the electronic programming guide such that selection of the server-based television channel causes a display of media data received via the network. In some examples, the operations may include receiving, from the display device, a search query to search media content in the media provider database, the search query including one or more terms submitted by a user of the display device, and, in response to the search query, transmitting search results for display on the user interface associated with the display device. The search results may identify one or more programs broadcasted by one or more tuner-based television channels that were previously reconciled and recorded as an entitlement. In some examples, the user interface is configured to display television recommendations, where the channel and program data is configured to cause the program broadcasted by the tuner-based television channel to be included in the television recommendations.

In some aspects, the techniques described herein relate to a non-transitory computer-readable medium storing executable instructions that when executed by at least one processor cause the at least one processor to execute operations, where the operations include receiving, by a server computer, tuner channel data identifying a tuner-based television channel scanned by a television tuner of a display device, retrieving, from a media provider database, a list of tuner-based television channels associated with a location of the display device, identifying the tuner-based television channel from the list using the tuner channel data, including obtaining an identifier that identifies the tuner-based television channel in the media provider database, transmitting a program query to the media provider database, the program query including the identifier and information that identifies a time interval, receiving a program response from the media provider database, the program response including program data that identifies a program broadcasted by the tuner-based television channel during the time interval, and transmitting, over a network, the program data for display on a user interface of a media application executable by the display device, the program data, when displayed, configured to enable a user to select the tuner-based television channel from the user interface such that such that selection of the tuner-based television channel causes a display of media data from radio waves received via an antenna on the display device.

In some aspects, the techniques described herein relate to a non-transitory computer-readable medium, wherein the tuner channel data includes at least one of a channel name or a channel number, wherein the identifying includes matching at least one of the channel name or the channel number with at least one of a channel name or a channel number from the list of tuner-based television channels.

In some aspects, the techniques described herein relate to a non-transitory computer-readable medium, wherein the program data is configured to be displayed in an electronic programming guide, the electronic programming guide identifying the tuner-based television channel and a server-based television channel for selection by the user.

In some aspects, the techniques described herein relate to a non-transitory computer-readable medium, wherein the program data is configured to be displayed in a cluster of media content items on the user interface, the cluster of media content items including the program broadcasted by the tuner-based television channel and one or more programs available for streaming from one or more streaming platforms.

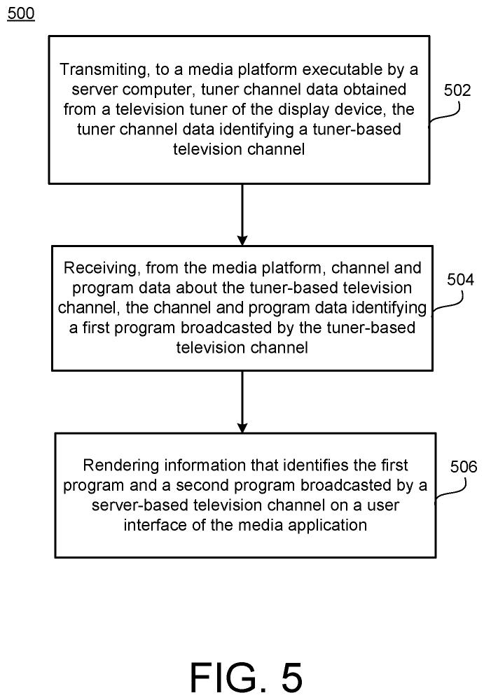

FIG. 5 illustrates a flowchart 500 depicting example operations of a display device for integrating tuner-based content into a server-based television platform according to an aspect. Although the flowchart 500 of FIG. 5 illustrates the operations in sequential order, it will be appreciated that this is merely an example, and that additional or alternative operations may be included. Further, operations of FIG. 5 and related operations may be executed in a different order than that shown, or in a parallel or overlapping fashion. The operations may define a computer-implemented method. Although the flowchart 500 is described with reference to the system 100 of FIGS. 1A through 1D, the flowchart 500 may be executed according to any of the figures discussed herein. In some examples, the operations of the flowchart 500 are executed by a network-enabled display device.

Operation 502 includes transmitting, to a media platform executable by a server computer, tuner channel data obtained from a television tuner of the display device, the tuner channel data identifying a tuner-based television channel. Operation 504 includes receiving, from the media platform, channel and program data about the tuner-based television channel, the channel and program data identifying a first program broadcasted by the tuner-based television channel. Operation 506 includes rendering information that identifies the first program and a second program broadcasted by a server-based television channel on a user interface of the media application.

In some aspects, the techniques described herein relate to a display device, wherein the media application is configured to: receive, via the user interface, a selection to the first program; and launch a media player to display content of the first program from media data received via the tuner.

In some aspects, the techniques described herein relate to a display device, wherein the media application is configured to: receive a voice command to watch the first program or the tuner-based television channel; and launch a media player to display content of the first program from media data received via the tuner.

In some aspects, the techniques described herein relate to a display device, wherein the media application is configured to: render an electronic programming guide in the user interface, the electronic programming guide identifying the tuner-based television channel and the server-based television channel.

In some aspects, the techniques described herein relate to a display device, wherein the media application is configured to: render a cluster of media content items on the user interface, the cluster of media content items including the first program broadcasted by the tuner-based television channel and one or more programs available for streaming from one or more streaming platforms.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or non-transitory medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
receiving, by a server computer, tuner channel data identifying a tuner-based television channel scanned by a television tuner of a display device;
retrieving, from a media provider database, a list of tuner-based television channels associated with a location of the display device;
identifying the tuner-based television channel from the list using the tuner channel data;
retrieving, from the media provider database, program data that identifies a program broadcasted by the tuner-based television channel;
generating channel and program data for the tuner-based television channel based on the tuner channel data and the program data; and
transmitting, over a network, the channel and program data to the display device, the channel and program data configured to cause the display device to display at least a portion of the program data in a user interface of a media application executable by the display device.

2. The method of claim 1, further comprising:
retrieving, from the media provider database, channel data for the tuner-based television channel, wherein the channel and program data for the tuner-based television channel includes the channel data.

3. The method of claim 2, wherein the channel data includes information that identifies an image associated with the tuner-based television channel.

4. The method of claim 1, wherein the tuner channel data includes at least one of a channel name or a channel number, wherein the identifying includes matching at least one of the channel name or the channel number with at least one of a channel name or a channel number from the list of tuner-based television channels.

5. The method of claim 1, further comprising:
in response to identifying the tuner-based television channel from the list, obtaining an identifier associated with the tuner-based television channel;
transmitting a program query to the media provider database, the program query including the identifier and information that identifies a time interval; and
receiving a program response from the media provider database, the program response including the program data that identifies the program broadcasted by the tuner-based television channel.

6. The method of claim 5, wherein the program data includes at least of a program name, a description, an air date, a maturity rating, and a program image.

7. The method of claim 1, further comprising:
storing, at the server computer, entitlement data associated with an account identifier or a device identifier, the entitlement data identifying a plurality of tuner-based television channels associated with the account identifier or the device identifier;
receiving, from the display device, new tuner channel data in response to a new channel scan by the television tuner;
in response to the new tuner channel data, generating updated channel and program data; and
updating the entitlement data with the updated channel and program data.

8. The method of claim 1, wherein the channel and program data is first channel and program data, the method further comprising:
generating electronic programming guide data, the electronic programming guide data including the first channel and program data associated with the tuner-based television channel, and second channel and program data for a server-based television channel; and
transmitting the electronic programming guide data to the display device, the electronic programming guide data configured to be rendered in an electronic programming guide in the user interface of the media application, the electronic programming guide identifying the tuner-based television channel and the server-based television channel.

9. The method of claim 8, wherein:
the electronic programming guide data, when rendered in the electronic programming guide, is configured to enable a user to select the tuner-based television channel from the electronic programming guide such that selection of the tuner-based television channel causes a display of media data from radio waves received via an antenna on the display device; and
the electronic programming guide data, when rendered in the electronic programming guide, is configured to enable the user to select the server-based television channel from the electronic programming guide such that selection of the server-based television channel causes a display of media data received via the network.

10. The method of claim 1, further comprising:
receiving, from the display device, a search query to search media content in the media provider database, the search query including one or more terms submitted by a user of the display device; and
in response to the search query, transmitting search results for display on the user interface associated with the display device, the search results identifying one or more programs broadcasted by one or more tuner-based television channels that were previously reconciled and recorded as an entitlement.

11. The method of claim 1, wherein the user interface is configured to display television recommendations, the channel and program data configured to cause the program broadcasted by the tuner-based television channel to be included in the television recommendations.

12. A non-transitory computer-readable medium storing executable instructions that when executed by at least one processor cause the at least one processor to execute operations, the operations comprising:
receiving, by a server computer, tuner channel data identifying a tuner-based television channel scanned by a television tuner of a display device;
retrieving, from a media provider database, a list of tuner-based television channels associated with a location of the display device;
identifying the tuner-based television channel from the list using the tuner channel data, including obtaining an identifier that identifies the tuner-based television channel in the media provider database;
transmitting a program query to the media provider database, the program query including the identifier and information that identifies a time interval;
receiving a program response from the media provider database, the program response including program data that identifies a program broadcasted by the tuner-based television channel during the time interval; and
transmitting, over a network, the program data for display on a user interface of a media application executable by the display device, the program data, when displayed, configured to enable a user to select the tuner-based television channel from the user interface such that such that selection of the tuner-based television channel causes a display of media data from radio waves received via an antenna on the display device.

13. The non-transitory computer-readable medium of claim 12, wherein the tuner channel data includes at least one of a channel name or a channel number, wherein the identifying includes matching at least one of the channel name or the channel number with at least one of a channel name or a channel number from the list of tuner-based television channels.

14. The non-transitory computer-readable medium of claim 12, wherein the program data is configured to be displayed in an electronic programming guide, the electronic programming guide identifying the tuner-based television channel and a server-based television channel for selection by the user.

15. The non-transitory computer-readable medium of claim 12, wherein the program data is configured to be displayed in a cluster of media content items on the user interface, the cluster of media content items including the program broadcasted by the tuner-based television channel and one or more programs available for streaming from one or more streaming platforms.

16. A display device comprising:
an operating system; and
a media application executable by the operating system, the media application configured to:
transmit, to a media platform executable by a server computer, tuner channel data obtained from a television tuner of the display device, the tuner channel data identifying a tuner-based television channel;
receive, from the media platform, channel and program data about the tuner-based television channel, the channel and program data identifying a first program broadcasted by the tuner-based television channel; and
render information that identifies the first program and a second program broadcasted by a server-based television channel on a user interface of the media application.

17. The display device of claim 16, wherein the media application is configured to:
receive, via the user interface, a selection to the first program; and
launch a media player to display content of the first program from media data received via the tuner.

18. The display device of claim 16, wherein the media application is configured to:
receive a voice command to watch the first program or the tuner-based television channel; and
launch a media player to display content of the first program from media data received via the tuner.

19. The display device of claim 16, wherein the media application is configured to:
render an electronic programming guide in the user interface, the electronic programming guide identifying the tuner-based television channel and the server-based television channel.

20. The display device of claim 16, wherein the media application is configured to:
render a cluster of media content items on the user interface, the cluster of media content items including the first program broadcasted by the tuner-based television channel and one or more programs available for streaming from one or more streaming platforms.
